(19) United States
(12) Patent Application Publication
(10) Pub. No.: US 2013/0271419 A1
(43) Pub. Date: Oct. 17, 2013

(54) TRANSFORMING MOBILE DEVICE SENSOR INTERACTION TO REPRESENT USER INTENT AND PERCEPTION

(71) Applicants: Sangita Sharma, Portland, OR (US); David L. Graumann, Portland, OR (US); Lakshman Krishnamurthy, Portland, OR (US); Jameson H. Williams, Portland, OR (US)

(72) Inventors: Sangita Sharma, Portland, OR (US); David L. Graumann, Portland, OR (US); Lakshman Krishnamurthy, Portland, OR (US); Jameson H. Williams, Portland, OR (US)

(21) Appl. No.: 13/995,897

(22) PCT Filed: Sep. 30, 2011
(86) PCT No.: PCT/US11/54408

§ 371 Date: Jun. 19, 2013

(51) Int. Cl. G06F 3/041

(52) U.S. Cl. CPC G06F 3/0416
USPC 345/173

(57) ABSTRACT

Transforming mobile device sensor interaction to represent user intent and perception. An embodiment of a mobile device includes a display screen for the display of data and images and a touch sensor to detect a motion of a gesture made by a thumb or other finger of a user of the device. The mobile device further includes a module to transform the motion detected by the touch sensor to generate a modified motion to reflect a perception of the user, where the modified motion is to be applied as an input relating to the display screen.

### TECHNICAL FIELD

Embodiments of the invention generally relate to the field of electronic devices and, more particularly, to transforming mobile device sensor interaction to represent user intent and perception.

### BACKGROUND

A user of a mobile device, including a cellular phone, smart phone, mobile Internet device (MID), handheld computer, personal digital assistant (PDA), or other similar device, may be required to input certain commands using gestures on a sensor input.

For example, sensors may include a touch sensor for inputs generated by movement of a thumb or other finger of a user of the mobile device. The touch sensor may include a capacitive sensor sensing contact with the sensor.

However, with certain types of sensor inputs, the user's intent may not be correctly understood by the device because the user's intention and perception of a rendered gesture does not match the actual gesture. For example, a gesture may be affected by the normal physical limitations of a user attempting to provide input using a thumb or other finger while grasping a mobile device.

### BRIEF DESCRIPTION OF THE DRAWINGS

Embodiments of the invention are illustrated by way of example, and not by way of limitation, in the figures of the accompanying drawings in which like reference numerals refer to similar elements.

FIG. 1 illustrates an embodiment of a mobile device to transform sensor data to represent user intent and perception;

FIG. 2 illustrates motion that is processed by an embodiment of a mobile device;

FIG. 3 is a graph to illustrate an amplification factor for sensor movement for an embodiment of a mobile device;

FIG. 4 is an illustration of an embodiment of elements of a mobile device to transform sensor data to represent user intent and perception;

FIG. 5 is a flowchart to illustrate an embodiment of a process for transforming sensor data to represent user intent and perception based on contact area;

FIG. 6 is a flowchart to illustrate an embodiment of a process for transforming sensor data to represent user intent and perception based on a type of usage demonstrated by speed of motion; and

FIG. 7 illustrates an embodiment of a mobile device to transform sensor data to represent user intent and perception.

### DETAILED DESCRIPTION

Embodiments of the invention are generally directed to warping mobile device sensor interaction to user intent and perception.

As used herein:

“Mobile device” means a mobile electronic device or system including a cellular phone, smart phone, mobile Internet device (MID), handheld computers, personal digital assistants (PDAs), and other similar devices.

“Touch sensor” means a sensor that is configured to provide input signals that are generated by the physical contact of a user, proximity of a user, or both (which may generally be referred to as contact with the touch sensor), including a sensor that detects contact by a thumb or other finger of a user of a device or system, including a mobile device. A touch sensor may include, but is not limited to, a capacitive sensor, which may detect the contact of a finger or hand on the capacitive sensor. A touch sensor may include a sensor used for multiple different purposes in the operation of a device or system.

“Side touch sensor” means a touch sensor that detects contact of a user, including a user's finger or hand, on at least one side of a device or system including a mobile device. A side touch sensor includes a touch sensor that is physically located at least in part on one side of the mobile device, or a side touch sensor that detects contact with a user on the side of the mobile device without being physically located on the side on the mobile device.

A mobile device will commonly include an input device such as a touch sensor that may allow for input of commands or directions through a gesture performed by a user. In an example, an embodiment of a mobile device may include a side touch sensor that a user may utilize through gestures performed using a thumb or other finger. The uses of the side touch sensor may vary widely. In one example, mobile Internet browsing on mobile device is increasingly common, and a mobile device may utilize thumb interaction on the side touch sensor to provide for user control in such Internet browsing.

However, a user's perception of a gesture performed on a touch sensor may not match the reality of the gesture because of the limitations of the touch sensor and because of the nature of motion and contact by a thumb or other finger on the touch sensor.

For example, if a user's hand is generally not in motion because the mobile device is held in this hand, a gesture up and down (which may be referred to as the Y-axis, in contrast with sideways motions along the X-axis) on a side touch sensor by the user's thumb will be a motion between the large fleshy potion of the thumb at an upper limit and a smaller tip of the thumb at a lower limit. Because of the structure and biomechanical limitations of the thumb and the positioning on a sensor, although a user may perceive a gesture in the Y-axis as being at a constant rate of speed, in actuality the rate will be faster when using the tip of the thumb than when using the fleshy portion of the thumb. For this reason, there is a disconnect between the user's intent and the actual gesture being made as detected by the sensor.

Further, because of the structure of the thumb on a side sensor and the relatively limited amount of motion, there may also be a challenge to a user to move the thumb in a fashion that is consistent with an activity, such as Internet browsing, that may involve varying activities depending on what the user is attempting to accomplish at a certain points in time, which may require very different amounts of motion. However, again the amount of motion detected by the sensor does not generally match the user's perception, thus creating difficulties for a user.

In some embodiments, a mobile device operates to transform or warp sensor interaction to align more closely with user intent and perception. In some embodiments, a mobile device may utilize a combination of techniques for calibrating touch sensor readings to human intent and perception to improve a user's experience in operating a mobile device utilizing a side touch sensor. In an example, the techniques may be utilized such that the mobile device produces a smooth browsing experience in varying types of operations.

For the purpose of this discussion, a single finger interaction is defined as a continuous interaction between positions on a touch sensor by a finger, such as finger-down on the sensor (start of the interaction) followed by finger-up (end of the interaction).

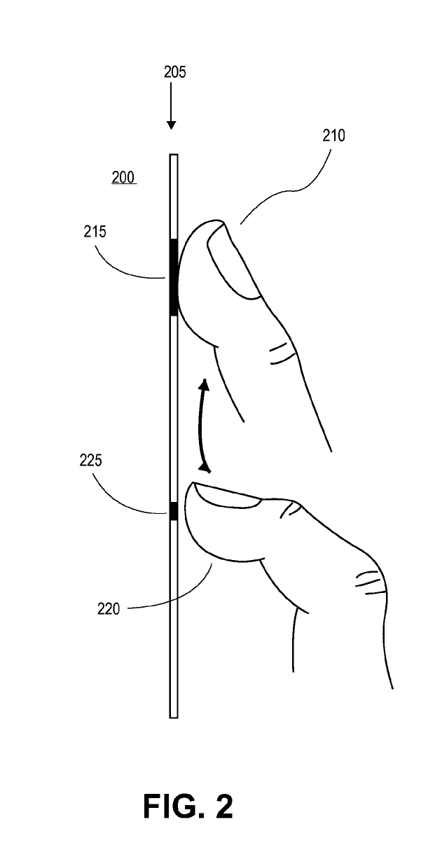

In a typical thumb interaction on a side touch sensor, the thumb often transitions from its tip touching the sensor to the entire fleshy part landing on the sensor. This is shown in, for example, FIG. 2. This commonly occurs when the user is attempting to span the length of the touch sensor with the intent to, for example, scroll the view on a screen on the mobile device. During a single thumb motion across the sensor, the user intent typically is to provide a constant speed of motion, such as to scroll the screen of a mobile at a constant rate. However, sensor readings, such as readings detecting motion of the centroid (or barycenter) of a contact area on the sensor, obtained from a capacitive touch sensor will show that there is a mismatch between the human intent and relative change in the sensor readings. Specifically, the per-sample relative movement calculated based on the sensor readings during tip interaction is more than as it transitions to the fleshy part of the thumb, even though the human perception is that the gesture is performed at a constant rate.

In some embodiments, a mobile device operates using a technique that detects contact and motion, and hypothesizes what portion of the thumb is interacting with the side touch sensor at each point in time, and compensates for the variation in computed motion during the different portions of the thumb interaction.

In some embodiments, a size of a contact area made by a thumb or other finger, such as the height (or length) of the contact area, may be used as an indicator of what portion of the thumb is interacting with the side touch sensor. In some embodiments, the mobile device applies a scaling factor accordingly to correct or offset at least some of the variations in actual motion over the length of a gesture.

In addition, when a user is engaged in activity, such as mobile browsing, with a mobile device, during a single thumb interaction the user intent may be classified with regard to certain operations, with the mobile device determining a classification of intent based on a speed of motion of a gesture detected by the mobile device. In some embodiments, a speed may be attached to the motion based on the determined classification of intent of the user.

In some embodiments, a user interaction can be classified as trying to accomplish one of the following in an operation, including the example of browsing operation:

(1) Slow operation—In an example, slow smooth scrolling of browser content using a browser application, where a browser application is an application or program to allow access to information on a network, including Internet World Wide Web access. This may occur when, for example, a user is attempting to focus on and move through particular content on a page, and thus is attempting to move through the material on the page slowly. In some embodiments, an operation may be classified as slow operation if a gesture speed is less than a first threshold speed.

(2) Medium speed operation—In an example, when a user is scrolling to content of interest using a browser application, and thus engages in medium speed scrolling. This may occur, for example, when a user wants to quickly scan through major sub-sections of web-page content to reach certain content of interest. In some embodiments, an operation may be classified as medium operation if a gesture speed is more than a first threshold speed and less than second threshold, where the second threshold is greater than the first threshold.

(3) Fast operation—In an example, when a user is scrolling quickly through material in a browser application. This may occur when, for example, a user is aware that material for which the user is searching is located on a loaded page several screens down or up from a current location. In some embodiments, an operation may be classified as fast operation if a gesture speed is more than the second threshold speed.

In some embodiments, a mobile device provides for transitioning the different operations, such as, in mobile browsing, a transition between slow to medium movement as the user view content of interest and moves on to other content.

In operation of a mobile device with a side touch sensor, such as mobile browser scrolling using a browser application, if raw movements computed from the sensor readings or movements computed after applying the amplification factor are used directly (even with, for example, some form of standard pointer ballistics-like transformation), the result is a non-smooth scrolling user experience. A major factor for this that the human perception of constant speed does not translate into constant motion of the thumb. In addition to inherent noise in sensor readings, there are also human limitations in finger movement, which limit the success of activities such as scrolling in a mobile device. In some embodiments, a range of relative movement on a touch sensor is mapped onto distinct ranges of movement, such as three distinct ranges that represent slow, medium, and fast motion. In some embodiments, the ranges may be determined empirically. In some embodiments, computed per-sample relative movement is then mapped into one of the ranges, which results in a fixed output motion whilst in that particular range. Such a mapping may be used to translate operation into human perception of constant rate of movement.

In operation, the transition between the distinct ranges during a single interaction may result in a large jitter in the output. In some embodiments, transitions between ranges are handled by a scaling of motion, such as a standard dynamic scaling, in order to provide a perception of smooth transition.

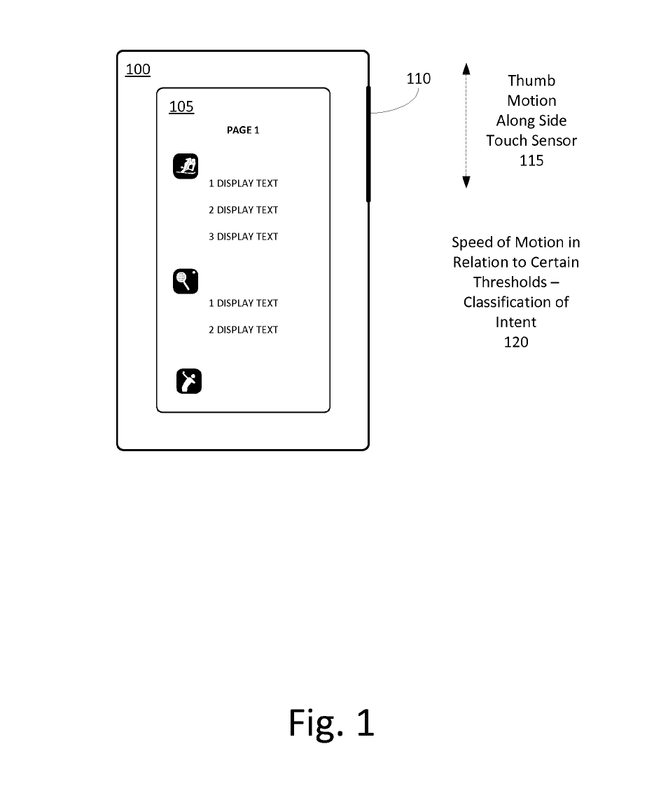

FIG. 1 illustrates an embodiment of a mobile device to transform sensor data to represent user intent and perception. In some embodiments, a mobile device 100 provides for warping or transforming mobile device sensor interaction to represent user intent and perception. In some embodiments, the mobile device 100 includes a screen 105 for viewing displayed information, which may include a touch screen that provides both for presenting data and images to a user and for receiving input from the user. In some embodiments, the mobile device 100 further includes a side touch sensor 110 for the receipt of inputs from a user in the form of gestures from a user's thumb or other finger.

In some embodiments, the mobile device operates in one or more functions to transform the input from the side touch sensor 110 to address the intent and perception of a user of the mobile device 100. For example, in a first function, the mobile device may provide for compensation for the variation in computed motion during the different portions of a thumb motion 115 along the side touch sensor 110, such as described above with regard to using contact area height (or other measurement of amount of contact on the side touch sensor) made by a thumb or other finger as an indicator of what portion of the thumb is interacting with the side touch sensor, and applies a scaling factor accordingly to correct or offset at least some of the variations in actual motion over the length of a gesture.

In a second function, the mobile device 100 provides for use of a speed of a motion of gesture in relation to certain thresholds to classify the type of operation of the mobile device, and to classify such usage. In some embodiments, the mobile device provides a constant rate of motion for a gesture in accordance with the chosen classification.

In some embodiments, the mobile device 100 may utilize the first function together with the second function. For example, the mobile device 100 may provide for applying a scaling factor to compensate for the variation in computed motion for a gesture; and for classifying the type of operation of the mobile device based on the compensated motion 120, and establishing a constant rate of motion in accordance with the chosen classification.

In some embodiments, the touch sensor 110 may include capacitive sensors and may also include other sensors, such as an optical sensor. See, for example, U.S. patent application Ser. No. 12/650,582, filed Dec. 31, 2009 (Optical Capacitive Thumb Control with Pressure Sensor); U.S. patent application Ser. No. 12/646,220, filed Dec. 23, 2009 (Contoured Thumb Touch Sensor Apparatus).

FIG. 2 illustrates motion that is processed by an embodiment of a mobile device. In some embodiments, a mobile device 200 includes a side touch sensor 205 for the detection of gestures generated by contact and motion of a thumb or other finger. For example, a gesture may include a motion of a thumb of a user up and down (which may also include side to side motion) on the side touch sensor. However, as described above, the biomechanical operation of a thumb on the touch sensor may result in results that do not match the intent and perception of the user.

In this illustration, a thumb of a user at a certain point in a gesture may be in a first position 210 such that the thumb is outstretched, such as a point in time when the thumb is at a highest point on the side touch sensor 205. In this position, the thumb will contact a fairly large area of the side touch sensor, as shown by the large contact area height 215 in relation to the size of the side touch sensor. In some embodiments, based on the contact area height, the mobile device will conclude that the thumb is in an extended position, and thus the motion will be relatively slow and will require a larger amplification factor to match the perception of the user regarding the speed of movement and the intent of the use in making the gesture.

In this illustration, a thumb of a user at a certain point in a gesture may be in a second position 220 such that the thumb is bent, such as a point in time when the thumb is at a lowest point on the side touch sensor 205. In this position, the thumb will contact a fairly small area of the side touch sensor because only the tip of the thumb will contact the side touch sensor, as shown by the small contact area height 225 in relation to the size of the side touch sensor. In some embodiments, based on the contact area height, the mobile device will conclude that the thumb is in a bent position, and thus the motion will be relatively fast and will require a smaller amplification factor to match the perception of the user regarding the speed of movement and the intent of the use in making the gesture.

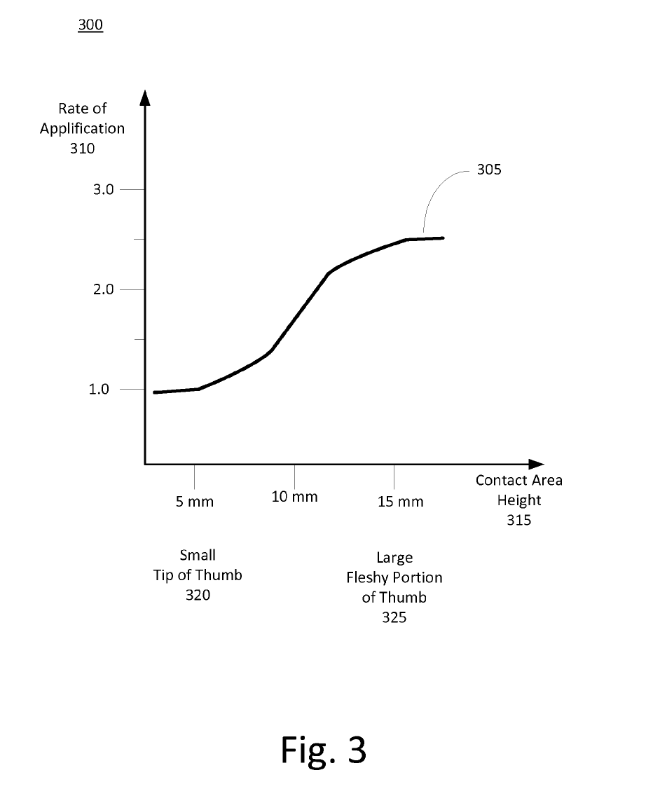

FIG. 3 is a graph to illustrate an amplification factor for sensor movement for an embodiment of a mobile device. In this illustration, a graph 300 provides an example of a curve 305 showing a rate of amplification 310 against contact area height 315, where the contact area height 315 represents a height of the contact detected by a side touch sensor of a mobile device. In some embodiments, the actual values of rates of amplification appropriate for different contact heights may be determined empirically by testing of operations of a mobile device by users. However, embodiments are not limited to any particular choice of rates of amplification, or any particular method choosing such rates of amplification.

In this illustration, when a small contact area height, such as 5 mm, is detected, this may presumed to be the result of the contact of a tip of a user's thumb on the side touch sensor 320. In such circumstance, it may be concluded that the thumb is in a bent position near the bottom of the side touch sensor, and that detected movement by the thumb in this position will be relatively fast. For this reason a low (˜1.0× in this example) amplification factor is applied to movement in this portion of a gesture.

However, when a large contact area height, such as 15 mm, is detected, this may be presumed to be the result of the contact of the fleshy portion of a user's thumb on the side touch sensor 325. In such circumstance, it may be concluded that the thumb is in an extended position near the top of the side touch sensor, and that detected movement by the thumb in this position will be relatively slow. For this reason a high (˜2.5× in this example) amplification factor is applied to movement in this portion of a gesture.

In addition, movement between the two discussed extremes may be subject to gradual change in amplification factor to result in an input to the mobile device that is smooth throughout the motion of the thumb as expected and perceived by the user of the device, while the actual motions detected have varied considerably from the start of finish of a gesture along the range of the touch sensor.

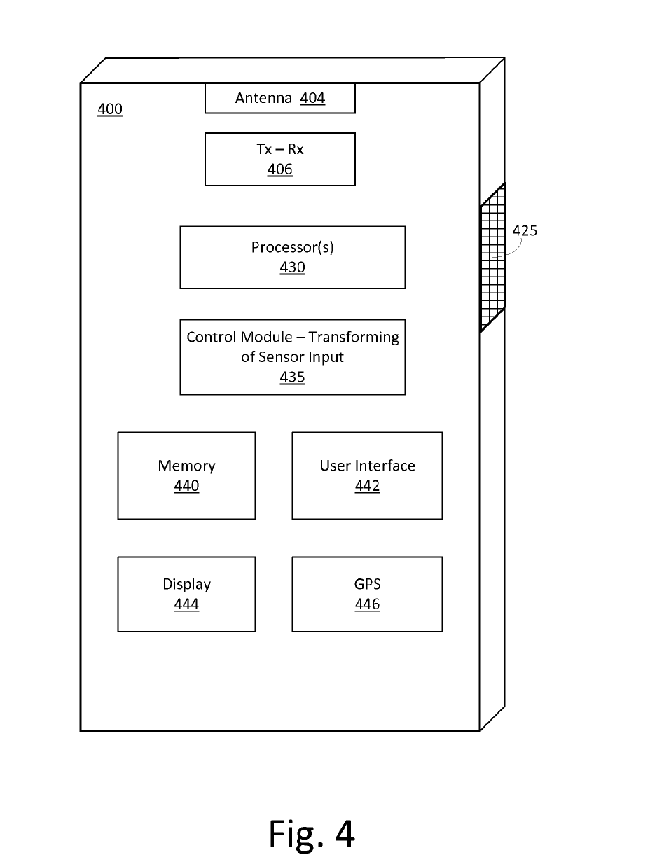

FIG. 4 is an illustration of an embodiment of elements of a mobile device to transform sensor data to represent user intent and perception. In some embodiments, the mobile device 400 includes a side touch sensor 425 for use in providing input to the mobile device through gesture operations of a thumb or other finger of the user. In some embodiments, the mobile device 400 further includes one or more processors 430 for the processing of signals and commands, including inputs received from the side touch sensor.

In some embodiments, the mobile device 400 includes a control module or algorithm 435 that receives signals from the side touch sensor and provides for transforming mobile device sensor interaction to represent user intent and perception. In some embodiments, the control module or algorithm includes one or both of:

(1) Providing a varying amplification factor for movement based on an amount of contact area (such as represented by contact area height), where a greater amplification factor is provided for a larger contact area to account for thumb position and angle; and

(2) Classification of movement based on relative speed of motion (such as slow, medium, or fast movement), and providing a certain constant rate of movement for a display according to the classification to reflect the expected type of user intended operation in such classification.

The mobile device may further include, for example, one or more transmitters and receivers 406 for the wireless transmission and reception of data, as well as one or more antennas 404 for such data transmission and reception; a memory 440 for the storage of data; a user interface 442, including a graphical user interface (GUI), for communications between the mobile device 400 and a user of the device; a display circuit or controller 444 for providing a visual display to a user of the mobile device 400; and a location circuit or element, including a (GPS) circuit or element 446.

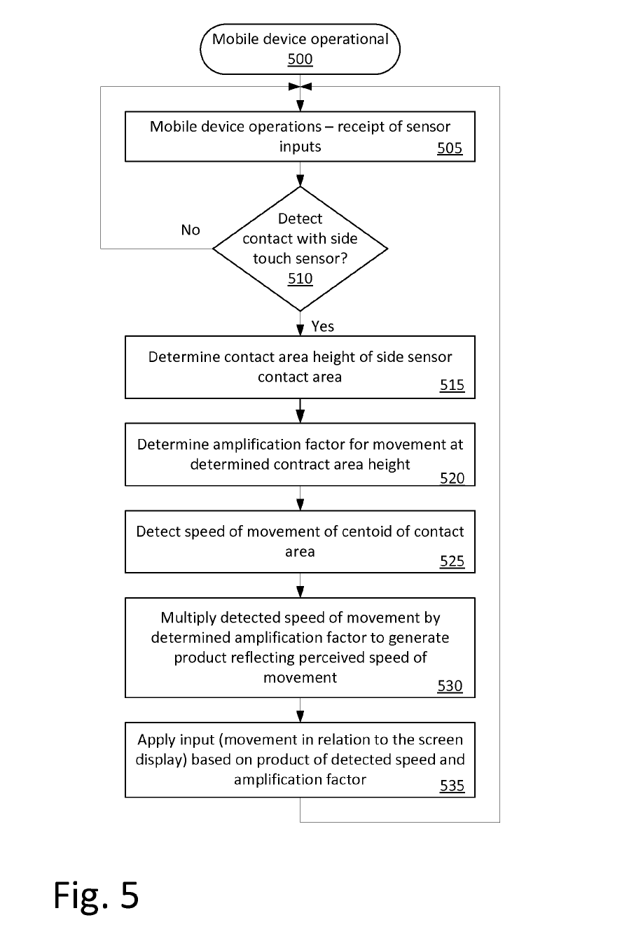

FIG. 5 is a flowchart to illustrate an embodiment of a process for transforming sensor data to represent user intent and perception based on contact area. In some embodiments, upon a mobile device becoming operational 500, the mobile device may proceed with normal operations, including receipt of sensor inputs 505. In some embodiments, the sensor inputs include input from a side touch sensor.

In some embodiments, if the mobile device detects contact with the side touch sensor 510, a determination is made regarding the height of the contact area 515. In some embodiments, an amplification factor for screen movement at the determined contact area height is determined 520, where the amplification factor may be based on an assumed thumb position and resulting motion characteristic represented by the contact area height.

In some embodiments, a speed of movement of the centroid of the contact area is determined 525, and the speed of movement is multiplied by the determined amplification factor to generate a product that represents a perceived and intended speed of movement by the user of the mobile device 530.

In some embodiments, the input, representing a movement in relation to the display screen, is applied based on the product of the speed of movement of the centroid and the amplification factor 535. In some embodiments, the mobile device thus transforms the detected movement to attempt to reflect the intended and perceived motion by the user of the mobile device.

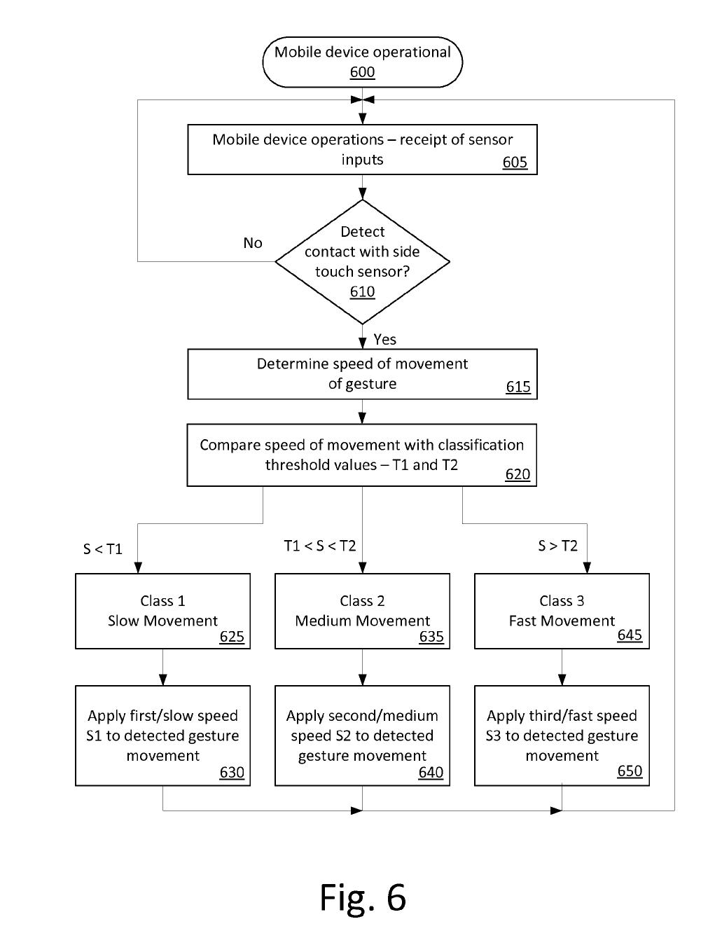

FIG. 6 is a flowchart to illustrate an embodiment of a process for transforming sensor data to represent user intent and perception based on a type of usage demonstrated by speed of motion. In some embodiments, upon a mobile device becoming operation 600, the mobile device may proceed with normal operations, including receipt of sensor inputs 605. In some embodiments, the sensor inputs include input from a side touch sensor.

Upon detecting contact with a side touch sensor 610, the mobile device determines a speed of motion of the gesture 615, which may be a speed of a centroid of the contact area on the side touch sensor. In some embodiments, the speed of motion may be compared with usage classification thresholds 620, wherein the thresholds may have been determined empirically to determine normal speeds of movement for certain types of operations on a touch sensor. In this particular example, the threshold values are a certain lower threshold T1 and a certain upper threshold T2 for simplicity. However, the thresholds are not limited to this structure, and may include, for example, certain bands of values or other types of thresholds.

In some embodiments, the movement is classified as belonging to one of a plurality of different classifications based on the comparison of the speed of movement on the sensor with the established threshold values. Using the values provided here as an example, if speed S is less than T1, then the movement is classified as Class 1—slow movement 625, such as in the slow movement made while reading during mobile browsing, and a constant first speed (a slow speed S1) is applied to the detected gesture movement 630. If speed S is greater than T1 but less than T2, then the movement is classified as Class 2—medium movement 635, such as in the medium speed movement made while moving between elements during mobile browsing, and a constant second speed (a medium speed S2, where S2 is greater than S1) is applied to the detected gesture movement 640. If speed S is greater than T2, then the movement is classified as Class 3—fast movement 645, such as in the fast movement made while flipping past pages of data in mobile browsing, and a constant third speed (a fast speed S3, where S3 is greater than S2) is applied to the detected gesture movement 650.

In some embodiments, the process illustrated in FIG. 6 may operate in conjunction with the process illustrated in FIG. 5. In an example, an apparatus, system, or method may provide for the application of a determined amplification factor to a motion of a gesture to generate a speed for a modified motion, such as illustrated in FIG. 5, and then the determination of a classification of operation using based upon the generated speed, resulting in applying a constant speed for the modified motion based on the determined classification.

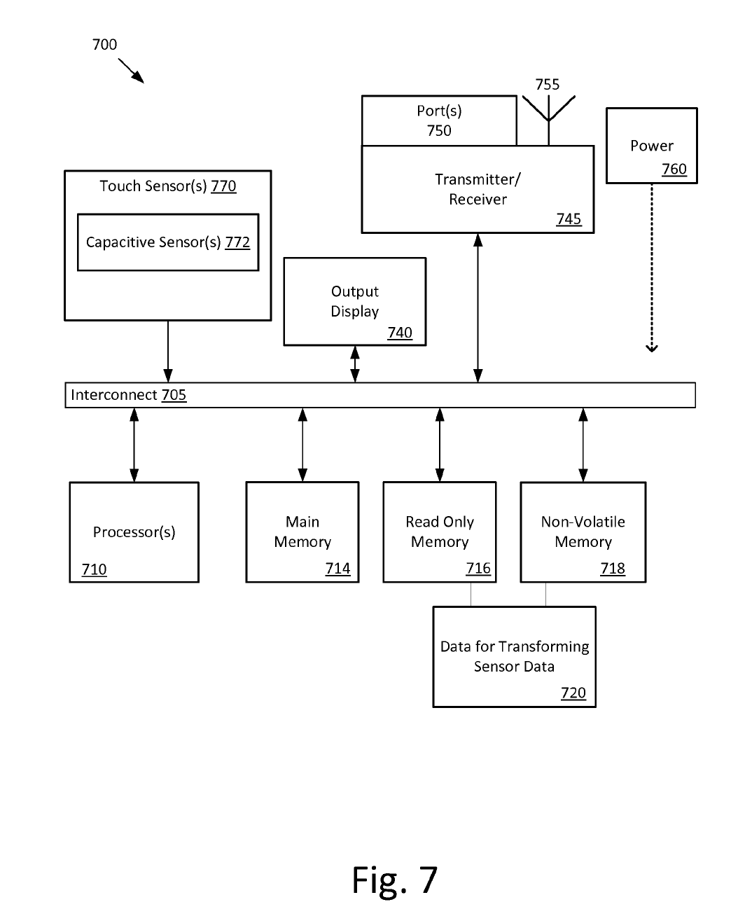

FIG. 7 illustrates an embodiment of a mobile device to transform sensor data to represent user intent and perception. In this illustration, certain standard and well-known components that are not germane to the present description are not shown. Under some embodiments, the mobile device 700 comprises an interconnect or crossbar 705 or other communication means for transmission of data. The device 700 may include a processing means such as one or more processors 710 coupled with the interconnect 705 for processing information. The processors 710 may comprise one or more physical processors and one or more logical processors. The interconnect 705 is illustrated as a single interconnect for simplicity, but may represent multiple different interconnects or buses and the component connections to such interconnects may vary. The interconnect 705 shown in FIG. 7 is an abstraction that represents any one or more separate physical buses, point-to-point connections, or both connected by appropriate bridges, adapters, or controllers.

In some embodiments, the device 700 includes one or more touch sensors 770. In some embodiments, the touch sensors 770 may includes capacitive sensors 772, and may include one or more other sensors, such as optical sensors. The touch sensors may further include a side touch sensor, such as side touch sensor 425 as illustrated in FIG. 4. In some embodiments, the device 700 provides for warping or transforming detected motion on the side touch sensor to represent user intent and perception regarding gestures made on the side touch sensor.

In some embodiments, the device 700 further comprises a random access memory (RAM) or other dynamic storage device or element as a main memory 714 for storing information and instructions to be executed by the processors 710. RAM memory includes dynamic random access memory (DRAM), which requires refreshing of memory contents, and static random access memory (SRAM), which does not require refreshing contents, but at increased cost. In some embodiments, main memory may include active storage of applications including a browser application for using in network browsing activities by a user of the device. DRAM memory may include synchronous dynamic random access memory (SDRAM), which includes a clock signal to control signals, and extended data-out dynamic random access memory (EDO DRAM). In some embodiments, memory of the system may include certain registers or other special purpose memory. The device 700 also may comprise a read only memory (ROM) 716 or other static storage device for storing static information and instructions for the processors 710. The device 700 may include one or more non-volatile memory elements 718 for the storage of certain elements. In some embodiments, the ROM memory 716 or the non-volatile memory 718, or both, may include storage of data regarding the transformation of sensor data to represent user perception and intent 720.

The device 700 may also be coupled via the interconnect 705 to an output display 740. In some embodiments, the display 740 may include a liquid crystal display (LCD) or any other display technology, for displaying information or content to a user. In some environments, the display 740 may include a touch-screen that is also utilized as at least a part of an input device. In some environments, the display 740 may be or may include an audio device, such as a speaker for providing audio information.

One or more transmitters or receivers 745 may also be coupled to the interconnect 705. In some embodiments, the device 700 may include one or more ports 750 for the reception or transmission of data. The device 700 may further include one or more antennas 755 for the reception of data via radio signals.

The device 700 may also comprise a power device or system 760, which may comprise a power supply, a battery, a solar cell, a fuel cell, or other system or device for providing or generating power. The power provided by the power device or system 760 may be distributed as required to elements of the device 700.

In the description above, for the purposes of explanation, numerous specific details are set forth in order to provide a thorough understanding of the present invention. It will be apparent, however, to one skilled in the art that the present invention may be practiced without some of these specific details. In other instances, well-known structures and devices are shown in block diagram form. There may be intermediate structure between illustrated components. The components described or illustrated herein may have additional inputs or outputs which are not illustrated or described.

Various embodiments may include various processes. These processes may be performed by hardware components or may be embodied in computer program or machine-executable instructions, which may be used to cause a general-purpose or special-purpose processor or logic circuits programmed with the instructions to perform the processes. Alternatively, the processes may be performed by a combination of hardware and software.

Portions of various embodiments may be provided as a computer program product, which may include a non-transitory computer-readable storage medium having stored thereon computer program instructions, which may be used to program a computer (or other electronic devices) for execution by one or more processors to perform a process according to certain embodiments. The computer-readable medium may include, but is not limited to, floppy diskettes, optical disks, compact disk read-only memory (CD-ROM), and magneto-optical disks, read-only memory (ROM), random access memory (RAM), erasable programmable read-only memory (EPROM), electrically-erasable programmable read-only memory (EEPROM), magnet or optical cards, flash memory, or other type of computer-readable medium suitable for storing electronic instructions. Moreover, embodiments may also be downloaded as a computer program product, wherein the program may be transferred from a remote computer to a requesting computer.

Many of the methods are described in their most basic form, but processes can be added to or deleted from any of the methods and information can be added or subtracted from any of the described messages without departing from the basic scope of the present invention. It will be apparent to those skilled in the art that many further modifications and adaptations can be made. The particular embodiments are not provided to limit the invention but to illustrate it. The scope of the embodiments of the present invention is not to be determined by the specific examples provided above but only by the claims below.

If it is said that an element “A” is coupled to or with element “B,” element A may be directly coupled to element B or be indirectly coupled through, for example, element C. When the specification or claims state that a component, feature, structure, process, or characteristic A “causes” a component, feature, structure, process, or characteristic B, it means that “A” is at least a partial cause of “B” but that there may also be at least one other component, feature, structure, process, or characteristic that assists in causing “B.” If the specification indicates that a component, feature, structure, process, or characteristic “may”, “might”, or “could” be included, that particular component, feature, structure, process, or characteristic is not required to be included. If the specification or claim refers to “a” or “an” element, this does not mean there is only one of the described elements.

An embodiment is an implementation or example of the present invention. Reference in the specification to “an embodiment,” “one embodiment,” “some embodiments,” or “other embodiments” means that a particular feature, structure, or characteristic described in connection with the embodiments is included in at least some embodiments, but not necessarily all embodiments. The various appearances of “an embodiment,” “one embodiment,” or “some embodiments” are not necessarily all referring to the same embodiments. It should be appreciated that in the foregoing description of exemplary embodiments of the present invention, various features are sometimes grouped together in a single embodiment, figure, or description thereof for the purpose of streamlining the disclosure and aiding in the understanding of one or more of the various inventive aspects. This method of disclosure, however, is not to be interpreted as reflecting an intention that the claimed invention requires more features than are expressly recited in each claim. Rather, as the following claims reflect, inventive aspects lie in less than all features of a single foregoing disclosed embodiment. Thus, the claims are hereby expressly incorporated into this description, with each claim standing on its own as a separate embodiment of this invention.

1. A mobile device comprising:
a display screen for the display of data and images;
a touch sensor to detect a motion of a gesture made by a thumb or other finger of a user of the device; and
a module to transform the motion detected by the touch sensor to generate a modified motion to reflect a perception of the user, wherein the modified motion is to be applied as an input relating to the display screen.

2. The mobile device of claim 1, wherein the mobile device is to determine a size of a contact area on the touch sensor.

3. The mobile device of claim 2, wherein the module is to determine an amplification factor for the detected motion based on the determined size of contact area and is to multiply a speed of the detected motion times the determined amplification factor to generate a speed for the modified motion.

4. (canceled)

5. The mobile device of claim 2, wherein a first size of a contact area represents a tip of a thumb or other finger in bent position and a second size of a contact area represents a wide portion of a thumb or other finger.

6. The mobile device of claim 5, wherein a first amplification factor for the first size of contact area is smaller than a second amplification factor for the second size of contact area.

7. The mobile device of claim 1, wherein the module is to determine a classification of operation for the gesture based on a speed of the detected motion.

8. The mobile device of claim 7, wherein the module is to establish a constant speed for the modified motion based on the determined classification.

9. The mobile device of claim 7, wherein the module is to determine the classification by comparing the speed of the detected motion with one or more thresholds.

10. The mobile device of claim 7, wherein the determined classification is one of a plurality of classifications, each classification representing a certain set of speeds of motion for a certain type of operation.

11. The mobile device of claim 1, wherein the touch sensor is a side touch sensor to detect contact with a side of the mobile device.

12. A method comprising:
detecting by a touch sensor of a mobile device a motion of a gesture made by a thumb or other finger of a user of the device;
transforming the motion detected by the touch sensor to reflect a perception of the user to generate a modified motion; and
applying the modified motion as an input to the mobile device relating to a display screen of the mobile device.

13. The method of claim 12, further comprising determining a size of a contact area on the touch sensor.

14. The method of claim 13, wherein transforming the motion includes determining an amplification factor for the detected motion based on the determined size of contact area and multiplying a speed of the detected motion times the determined amplification factor to generate a speed for the modified motion.

15. (canceled)

16. The method of claim 13, wherein a first size of a contact area represents a tip of a thumb or other finger in bent position and a second size of a contact area represents a wide portion of a thumb or other finger.

17. The method of claim 16, wherein a first amplification factor for the first size of contact area is smaller than a second amplification factor for the second size of contact area.

18. The method of claim 12, wherein transforming the detected motion includes determining a classification of operation for the gesture based on a speed of the detected motion.

19. The method of claim 18, wherein transforming the detected motion includes establishing a constant speed for the modified motion based on the determined classification.

20. The method of claim 19, determining the classification includes comparing the speed of the detected motion with one or more thresholds.

21. The method of claim 19, wherein the determined classification is one of a plurality of classifications, each classification representing a certain set of speeds of motion for a certain type of operation.

22. The method of claim 21, wherein the plurality of classifications include a first classification for slow motions, a second classification for medium speed motions, and a third classification for fast motions.

23. A system comprising:
a display screen for the display of data and images;
a side touch sensor to detect a motion of a gesture made by a thumb or other finger of a user of the device with respect to a side of the system;
a dynamic random access memory (DRAM) to hold an application; and
a module to transform the motion detected by the side touch sensor to generate a modified motion to reflect a perception of the user, the system to apply the modified motion as an input to the mobile device for the application.

24. The system of claim 23, wherein the application is a browser application.

25. The system of claim 23, wherein the system is to determine a size of a contact area on the touch sensor, the module determining an amplification factor for the detected motion for the application based on the determined size of contact area, the module multiplying a speed of the detected motion times the determined amplification factor to generate a speed for the modified motion.

26. The system of claim 23, wherein the module is to determine a classification of operation for the gesture based on a speed of the detected motion, and is to establish a constant speed for the modified motion based on the determined classification.

27. A non-transitory computer-readable medium having stored thereon data representing sequences of instructions that, when executed by a processor, cause the processor to perform operations comprising:
detecting by a touch sensor of a mobile device a motion of a gesture made by a thumb or other finger of a user of the device;
transforming the motion detected by the touch sensor to reflect a perception of the user to generate a modified motion; and
applying the modified motion as an input to the mobile device relating to a display screen of the mobile device.

28-29. (canceled)
